(19) United States
(12) Patent Application Publication
(10) Pub. No.: US 2007/0020495 A1
(43) Pub. Date: Jan. 25, 2007

(54) Power generating apparatus using solid oxide fuel cell

(76) Inventors: Yasue Tokutake, Nagano-shi (JP); Shigeaki Suganuma, Nagano-shi (JP); Misa Watanabe, Chandler, AZ (US); Michio Horiuchi, Nagano-shi (JP)

Correspondence Address: MORGAN & FINNEGAN, L.L.P., 3 WORLD FINANCIAL CENTER, NEW YORK, NY, 10281-2101, US

(21) Appl. No.: 11/396,205

(22) Filed: Mar. 30, 2006

(30) Foreign Application Priority Data
Jul. 19, 2005 (JP) 2005-208754

(51) Int. Cl. H01M 8/04; H01M 8/12

(52) U.S. Cl. 429/26; 429/30; 429/32

(57) ABSTRACT

The present invention relates to a power generating apparatus that generates electric power using a solid oxide fuel cell by directly exposing the fuel cell to a premixed gas combustion flame formed in an infrared gas space heater. The solid oxide fuel cell is built into an infrared radiator in such a manner as to face a burner of the gas space heater, and is supported at a prescribed angle of tilt. An anode electrode layer, which is directly exposed to the flame produced by the burner, is kept in a fuel-rich condition, while a cathode electrode layer is exposed to the atmosphere and thus kept in an air-rich condition.

### CROSS-REFERENCE TO RELATED APPLICATION

This application claims the priority of Japanese Patent Application Number 2005-208754, filed on Jul. 19, 2005.

### BACKGROUND OF THE INVENTION

1. Field of the Invention

The present invention relates to a power generating apparatus using a solid oxide fuel cell and, more particularly, to a handy and simple solid-oxide fuel-cell power generating apparatus comprising a solid oxide fuel cell and capable of generating power by directly exposing the fuel cell to a premixed gas combustion flame produced by a burner of a gas space heater without compromising the space-heating performance of the space heater, wherein the solid oxide fuel cell is fabricated by forming a cathode electrode layer and an anode electrode layer on a solid oxide substrate and by employing a simple structure that does not require hermetic sealing.

2. Description of the Related Art

Fuel cells so far developed can be classified into various types according to the method of power generation, one being the type of fuel cell that uses a solid electrolyte. In one example of the fuel cell that uses a solid electrolyte, a calcined structure made of yttria(Y₂O₃)-doped stabilized zirconia is used as an oxygen ion conducting solid oxide substrate. This fuel cell comprises a cathode electrode layer formed on one surface of the solid oxide substrate and an anode electrode layer on the opposite surface thereof, and oxygen or an oxygen-containing gas is supplied to the cathode electrode layer, while a fuel gas such as methane is supplied to the anode electrode layer.

In this fuel cell, the oxygen (O₂) supplied to the cathode electrode layer is converted into oxygen ions (O²⁻) at the boundary between the cathode electrode layer and the solid oxide substrate, and the oxygen ions are conducted through the solid oxide substrate into the anode electrode layer where the ions react with the fuel gas, for example, a methane gas (CH₄), supplied to the anode electrode layer, producing water (H₂O), carbon dioxide (CO₂), hydrogen (H₂), and carbon monoxide (CO). In this reaction process, the oxygen ions release electrons, and a potential difference therefore occurs between the cathode electrode layer and the anode electrode layer. Here, when lead wires are attached to the cathode electrode layer and the anode electrode layer, the electrons in the anode electrode layer flow into the cathode electrode layer via the lead wires and the fuel cell thus generates electric power. The operating temperature of this fuel cell is about 1000° C.

However, this type of fuel cell requires the provision of separate chambers, one being an oxygen or oxygen-containing gas supply chamber on the cathode electrode layer side and the other a fuel gas supply chamber on the anode electrode layer side; furthermore, as the fuel cell is exposed to oxidizing and reducing atmospheres at high temperatures, it has been difficult to increase the durability of the fuel cell.

On the other hand, there has been developed a fuel cell of the type that comprises a cathode electrode layer and an anode electrode layer formed on opposite surfaces of a solid oxide substrate, and that generates an electromotive force between the cathode electrode layer and the anode electrode layer by placing the fuel cell in a fuel gas mixture consisting of a fuel gas, for example, a methane gas, and an oxygen gas. The principle of generating an electromotive force between the cathode electrode layer and the anode electrode layer is the same for this type of fuel cell as for the above-described separate-chamber type fuel cell but, as the entire fuel cell can be exposed to substantially the same atmosphere, the fuel cell can be constructed as a single-chamber type cell to which the fuel gas mixture is supplied, and this serves to increase the durability of the fuel cell.

However, in this single-chamber fuel cell also, as the fuel cell has to be operated at a high temperature of about 1000° C., there is the danger that the fuel gas mixture may explode. Here, if the oxygen concentration is reduced to a level lower than the ignitability limit, to avoid such a danger, there occurs the problem that carbonization of the fuel, such as methane, progresses and the fuel cell performance degrades. In view of this, there has been developed a single-chamber fuel cell that can use a fuel gas mixture whose oxygen concentration is adjusted so as to be able to prevent the progress of carbonization of the fuel, while at the same time, preventing an explosion of the fuel gas mixture.

The fuel cell so far described is of the type that is constructed by housing the fuel cell in a chamber having a hermetically sealed structure; on the other hand, there is proposed an apparatus that generates power by placing a solid oxide fuel cell in or near a flame and thereby holding the solid oxide fuel cell at its operating temperature.

The fuel cell used in the above-proposed power generating apparatus comprises a zirconia solid oxide substrate formed in a tubular structure, a cathode electrode layer as an air electrode formed on the inner circumference of the tubular structure, and an anode electrode layer as a fuel electrode formed on the outer circumference of the tubular structure. This solid oxide fuel cell using the solid electrolyte is placed with the anode electrode layer exposed to a reducing flame portion of a flame generated from a combustion device to which the fuel gas is supplied. In this arrangement, radicals, etc. present in the reducing flame can be utilized as the fuel, while air is supplied by convection or diffusion to the cathode electrode layer inside the tubular structure, and the solid oxide fuel cell thus generates electric power.

The earlier described single-chamber fuel-cell obviates the necessity of strictly separating the fuel and the air as was the case with conventional solid oxide fuel cells, but instead has to employ a hermetically sealed construction. Further, to increase the electromotive force, a plurality of flat plate solid oxide fuel cells are stacked one on top of another and connected together using an interconnect material having high heat resistance and high electrical conductivity so as to be able to operate at high temperatures. As a result, the single-chamber fuel-cell device constructed from a stack of flat plate solid oxide fuel cells has the problem that the construction is not only large but also costly.

Furthermore, in operation, the temperature is gradually raised to the high operating temperature in order to prevent cracking of the solid oxide fuel cells; therefore, the single-chamber fuel-cell device requires a significant startup time, thus causing extra trouble.

In contrast, the above-proposed solid oxide fuel cell of tubular structure employs a construction that directly utilizes a flame; this type of fuel cell has the characteristic of being an open type, the solid electrolyte fuel cell not needing to be housed in a hermetically sealed container. As a result, this type of fuel cell can reduce the startup time, is simple in structure, and is therefore advantageous when it comes to reducing the size, weight, and cost of the fuel cell. Further, as the flame is directly used, this type of fuel cell can be incorporated in a conventional combustion apparatus or an incinerator or the like, and is thus expected to be used as a power-supply apparatus.

However, in this type of fuel cell, as the anode electrode layer is formed on the outer circumference of the tubular solid oxide substrate, radicals due to the flame are not supplied, in particular, to the lower half of the anode electrode layer, and effective use cannot be made of the entire surface of the anode electrode layer formed on the outer circumference of the tubular solid oxide substrate. This has degraded the power generation efficiency. There has also been the problem that, as the solid oxide fuel cell is directly and unevenly heated by the flame, cracking tends to occur due to rapid changes in temperature.

In view of the above situation, Japanese Unexamined Patent Publication No. 2004-139936, for example, proposes a power generating apparatus using a solid oxide fuel cell as a handy power supply means, wherein improvements in durability and power generation efficiency and reductions in size and cost are achieved by employing a solid oxide fuel cell of the type that directly utilizes a flame produced by burning a fuel, and by making provisions to apply the flame over the entire surface of the anode electrode layer formed on a flat plate solid oxide substrate.

As described above, the previously proposed solid-oxide fuel-cell power generating apparatus requires, in the case of the chamber type, the provision of an electric oven for heating the solid oxide fuel cell to its operating temperature and a supply device for supplying a fuel gas and oxygen or air; as a result, the apparatus itself is complex and large in construction, and the apparatus, as a power generating apparatus, has not been the type that laypersons can handle.

On the other hand, the previously proposed power generating apparatus using the solid oxide fuel cell that directly utilizes a flame requires the provision of a combustion device for producing a flame by burning a fuel, but has the advantage that a small, compact, and light-weight power generating apparatus can be achieved because a candle, a lighter, or another handy device, that can produce a flame, can be used as the combustion device. However, while power can be generated in a simple manner, this type of power generating apparatus has had problems such as safety concerns involved because it directly uses a flame and is unable to obtain a stable flame because the flame used is a diffusion flame; for these and other reasons, it has been difficult to use this apparatus for stable power generation.

It is, accordingly, an object of the present invention to provide a solid-oxide fuel-cell power generating apparatus that generates power using a solid oxide fuel cell by directly exposing the fuel cell to a flame and that is small, safe, and easy to handle; to achieve this, a premixed gas combustion flame produced by a burner of a gas space heater capable of stably supplying fuel is utilized when generating power using the solid oxide fuel cell, and the solid oxide fuel cell itself is built into an infrared radiator of the gas space heater so that the fuel cell is directly exposed to the flame.

### SUMMARY OF THE INVENTION

To solve the above problems, a solid-oxide fuel-cell power generating apparatus according to the present invention comprises: a solid oxide fuel cell having a solid oxide substrate, a cathode electrode layer formed on one surface of the substrate, and an anode electrode layer formed on a surface of the substrate opposite from the one surface; and an infrared radiator which supports the solid oxide fuel cell in such a manner that the anode electrode layer is directly exposed to a premixed gas combustion flame produced by a burner of a gas space heater, wherein power is generated by supplying components of the premixed gas combustion flame to the anode electrode layer and air to the cathode electrode layer.

A current collecting electrode provided in either one or both of the cathode electrode layer and the anode electrode layer is formed from a metal mesh or metal wire spreading over an entire surface of the electrode layer.

The solid oxide fuel cell is supported on the infrared radiator in such a manner as to be tilted at a prescribed angle, and the solid oxide fuel cell is integrally built into the infrared radiator with the anode electrode layer facing the burner.

When the burner is constructed to produce the premixed gas combustion flame in such a manner as to form an array of premixed gas combustion flames arranged in a straight line, the solid oxide fuel cell is built into the infrared radiator so that the surface of the anode electrode layer runs parallel to a direction in which the premixed gas combustion flames are arranged.

A plurality of such solid oxide fuel cells are built into the infrared radiator, and the plurality of solid oxide fuel cells are connected in series or parallel to each other and are provided with lead wires for extracting the generated power.

Current collecting electrodes provided in the cathode layers and the anode layers of the plurality of solid oxide fuel cells are each formed from a metal mesh or metal wire, and the plurality of solid oxide fuel cells are connected in series or parallel to each other by the metal mesh or metal wire extending from the current collecting electrode of each of the solid oxide fuel cells.

The infrared radiator forms an interior space having a closed top, and the premixed gas combustion flame produced by the burner is supplied into the interior space.

The solid oxide fuel cell comprises a plurality of cathode electrode layers formed on one surface of the solid oxide substrate and a plurality of anode electrode layers formed on a surface of the solid oxide substrate opposite from the one surface, and a plurality of fuel cells are formed by the anode electrode layers and the cathode electrode layers formed opposite each other across the solid oxide substrate.

As described above, the solid-oxide fuel-cell power generating apparatus according to the present invention comprises the solid oxide fuel cell, which includes the solid oxide substrate, the cathode electrode layer, and the anode electrode layer, and the infrared radiator, which supports the solid oxide fuel cell in such a manner that the anode electrode layer is directly exposed to the premixed gas combustion flame produced by the burner of the gas space heater, and electric power is generated by supplying components of the premixed gas combustion flame produced by the burner of the gas space heater to the anode electrode layer while supplying air to the cathode electrode layer. As a result, the premixed gas combustion flame produced by the burner of the gas space heater is not only formed consistently and stably at the burner ports but also burned safely, and the solid oxide fuel cell can be easily held at its operating temperature by the heat of the premixed gas combustion flame; furthermore, unburned components and radicals contained in the premixed gas combustion flame can be stably supplied as the fuel for the fuel cell.

Further, the infrared radiator of the gas space heater equipped with a gas-fired burner is used as a fuel cell mounting part, and the solid oxide fuel cell is built into the infrared radiator; the power generating apparatus thus constructed is small and compact and can be handled easily by laypersons. Furthermore, the power generating apparatus can generate electric power without compromising the space-heating performance of the space heater, and can be used as a handy apparatus for power generation. Moreover, as the power generating apparatus is constructed to use, as the fuel source, the premixed gas combustion flame produced by burning fuel in the gas space heater, a large power output can be obtained stably.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a diagram schematically showing a solid-oxide fuel-cell power generating apparatus according to the present invention when the apparatus is built into a gas-fired infrared space heater;

FIG. 2 is a diagram for explaining an embodiment of the solid-oxide fuel-cell power generating apparatus of the present invention adapted to be built into the gas-fired infrared space heater;

FIG. 3 is a diagram for explaining solid oxide fuel cells in the power generating apparatus shown in FIG. 2;

FIG. 4 is a diagram for explaining a modified example of the solid-oxide fuel-cell power generating apparatus of the present invention; and

FIG. 5 is a diagram for explaining how electric power is generated by a solid oxide fuel cell using a gas-fired flame as a fuel.

### DESCRIPTION OF THE PREFERRED EMBODIMENT

An embodiment of a solid-oxide fuel-cell power generating apparatus according to the present invention will be described below with reference to the drawings. However, before proceeding to the description of the solid-oxide fuel-cell power generating apparatus of the present embodiment, a previously proposed solid-oxide fuel-cell power generating apparatus will be described in order to clarify the features and advantages of the present embodiment.

FIG. 5 shows the previously proposed solid-oxide fuel-cell power generating apparatus. The solid oxide fuel cell C used in the power generating apparatus shown in FIG. 5 comprises a flat plate solid oxide substrate 1 circular or rectangular in shape, a cathode electrode layer 2 as an air electrode formed on one surface of the substrate, and an anode electrode layer 3 as a fuel electrode formed on the opposite surface thereof. The cathode electrode layer 2 and the anode electrode layer 3 are disposed in such a manner as to face each other with the solid oxide substrate 1 interposed therebetween.

The power generating apparatus is constructed using the thus constructed solid oxide fuel cell C; more specifically, the fuel cell C with the anode electrode layer 3 facing down is placed above a combustion device 4 to which a fuel gas is supplied, and power is generated by directly exposing the anode electrode layer 3 to a flame f formed by the combustion of the fuel. A fuel that burns and oxidizes by forming a flame is supplied as the fuel to the combustion device 4. As the fuel, phosphorus, sulfur, fluorine, chlorine, or their compounds may be used, but an organic substance that does not need exhaust gas treatment is preferable. Such organic fuels include, for example, gases such as methane, ethane, propane, and butane, gasoline-based liquids such as hexane, heptane, octane, alcohols such as methanol, ethanol, and propanol, ketons such as acetone, and various other organic solvents, edible oil, kerosene, paper, wood, etc. Of these fuels, a gaseous fuel is particularly preferable.

Further, the flame may be a diffusion flame or a premixed gas combustion flame, but a premixed gas combustion flame is preferred for use, because the diffusion flame is unstable and tends to incur degradation of the performance of the anode electrode layer due to the production of soot. The premixed gas combustion flame is not only stable but the flame size is easily adjustable; in addition, the production of soot can be prevented by adjusting the fuel density.

As the solid oxide fuel cell is formed in a flat plate shape, the flame f produced by the combustion device 4 can be applied uniformly over the anode electrode layer 3 of the solid oxide fuel cell C; that is, compared with the tubular type, the flame f can be applied evenly. Furthermore, with the anode electrode layer 3 disposed facing the flame f, hydrocarbons, hydrogen, radicals (OH, CH, C2, O₂H, CH₃), etc. present in the flame can be easily utilized as the fuel to generate power based on the oxidation-reduction reaction. Further, the cathode electrode layer 2 is exposed to an oxygen-containing gas, for example, air, making it easier to utilize the oxygen from the cathode electrode layer 2; here, if provisions are made to blow the oxygen-containing gas toward the cathode electrode layer 2, the cathode electrode layer can be maintained in an oxygen-rich condition more efficiently.

The power generated by the solid oxide fuel cell C is taken between the lead wires L1 and L2 brought out from the cathode electrode layer 2 and the anode electrode layer 3, respectively. For the lead wires L1 and L2, platinum or a platinum-containing alloy is used.

As described above, the previously proposed power generating apparatus using the solid oxide fuel cell that directly utilizes a flame requires the provision of the combustion device for producing a flame by burning a fuel, but has the advantage that a small, compact, and light-weight power generating apparatus can be achieved because a candle, a lighter, or another handy device, that can produce a flame, can be used as the combustion device. However, while power can be generated in a simple manner, this type of power generating apparatus has had problems such as safety concerns because it directly uses a flame and an inability to obtain a stable flame because the flame used is a diffusion flame; for these and other reasons, it has been difficult to use this apparatus for stable power generation.

In view of the above, in the present invention, a premixed gas combustion flame produced by a burner of a gas space heater capable of stably supplying fuel is utilized when generating power using the solid oxide fuel cell, and the solid oxide fuel cell itself is built into an infrared radiator of the gas space heater so that power is generated by directly exposing the solid oxide fuel cell to the flame.

The solid oxide fuel cell that can be used in the power generating apparatus of the present embodiment will be described below.

The structure of the solid oxide fuel cell used in the present embodiment is basically the same as that of the solid oxide fuel cell C shown in FIG. 5, and comprises a solid oxide substrate 1, a cathode electrode layer 2, and an anode electrode layer 3.

The solid oxide substrate 1 is, for example, a flat rectangular plate, and the cathode electrode layer 2 and the anode electrode layer 3 are respectively formed over almost the entire surface of the flat solid oxide substrate 1 in such a manner as to face each other with the solid oxide substrate 1 interposed therebetween. A lead wire L1 is connected to the cathode electrode layer 2 and a lead wire L2 to the anode electrode layer 3, and the fuel cell output is taken between the lead wires L1 and L2. The solid oxide substrate 1 need only be formed in a plate-like shape, and need not be limited to the rectangular shape but can be formed in any suitable shape as long as it is at least shaped so as to be exposed to the premixed gas combustion flame produced by the burner of the gas space heater; for example, the substrate can even be formed in a circular shape.

For the solid oxide substrate 1, known materials can be used, examples including the following:

a) YSZ (yttria-stabilized zirconia), ScSZ (scandia-stabilized zirconia), and zirconia-based ceramics formed by doping these materials with Ce, Al, etc.

b) SDC (samaria-doped ceria), GDC (gadolinium-doped ceria), and other ceria-based ceramics.

c) LSGM (lanthanum gallate) and bismuth oxide-based ceramics.

For the anode electrode layer 3, known materials can be used, examples including the following:

d) Cermet of nickel and a ceramic based on yttria-stabilized zirconia or scandia-stabilized zirconia or a ceramic based on ceria (SDC, GDC, YDC, etc.).

e) Sintered material composed principally of electrically conductive oxide (50% to 99% by weight) (electrically conductive oxide is, for example, nickel oxide containing lithium in solid solution).

f) Material given in d) or e) to which a metal made of a platinum-group metallic element or its oxide is added in an amount of about 1% to 10% by weight.

Of these materials, d) and e) are particularly preferable.

The sintered material composed principally of electrically conductive oxide given in e) has excellent oxidation resistance and, therefore, can prevent phenomena resulting from the oxidation of the anode electrode layer, such as delamination of the anode electrode layer from the solid oxide layer and degradation of power generation efficiency or inability to generate power due to the rise in the electrode resistance of the anode electrode layer. For the electrically conductive oxide, nickel oxide containing lithium in a solid solution is preferable. It will also be noted that high power generation performance can be obtained by adding a metal made of a platinum-group metallic element or its oxide to the material given in d) or e).

For the cathode electrode layer, known materials, which contain an element, such as lanthanum, selected from group III of the periodic table and doped with strontium (Sr), can be used, examples include a manganic acid compound (for example, lanthanum strontium manganite), a gallium acid compound and a cobalt acid compound (for example, lanthanum strontium cobaltite and samarium strontium cobaltite).

The cathode electrode layer 2 and the anode electrode layer 3 are each formed as a porous structure. For these electrode layers, the porosity of the porous structure should be set to 20% or higher, preferably 30 to 70%, and more preferably 40 to 50%. In the solid oxide fuel cell used in the present embodiment, the cathode electrode layer 2 and the anode electrode layer 3 are both formed in a porous structure, thereby making it easier to supply the oxygen in the air over the entire surface of the interface between the cathode electrode layer 2 and the solid oxide substrate 1 and also making it easier to supply the fuel over the entire surface of the interface between the anode electrode layer 3 and the solid oxide substrate 1.

The solid oxide substrate 1 also can be formed as a porous structure. If the solid oxide substrate were formed in a closely compacted structure, its thermal shock resistance would drop, and the substrate would easily tend to crack when subjected to rapid temperature changes. Furthermore, as the solid oxide substrate is generally formed thicker than the anode electrode layer and the cathode electrode layer, any crack occurring in the solid oxide substrate would lead to the formation of cracks in the entire structure of the solid oxide fuel cell which would eventually disintegrate.

When the solid oxide substrate is formed in a porous structure, its thermal shock resistance increases, and defects such as cracking do not occur even when the substrate is subjected to rapid temperature changes or to a heat cycle involving rapid changes in temperature during power generation. Further, when the porous structure was fabricated with a porosity of less 10%, no appreciable improvement in thermal shock resistance was observed, but when the porosity was 10% or higher, good thermal shock resistance was observed, and a better result was obtained when the porosity was increased to 20% or higher. This is presumably because, when the solid oxide substrate is formed in a porous structure, thermal expansion due to heating is absorbed by the pores in the porous structure.

The solid oxide fuel cell C is fabricated, for example, in the following manner. First, powders of materials for forming the solid oxide substrate are mixed in prescribed proportions, and the mixture is molded into a plate-like shape. After that, the flat plate-like structure is calcined and sintered to produce the solid oxide layer which serves as the substrate. Here, by adjusting the kinds and proportions of the powder materials including a pore-forming agent and the calcination conditions such as calcination temperature, calcination time, preliminary calcination, etc., solid oxide substrates with various porosities can be produced. A paste is applied in the shape of a cathode electrode layer on one surface of the substrate thus obtained as the solid oxide layer, and a paste is applied in the shape of an anode electrode layer on the opposite surface thereof; thereafter, the entire structure is calcined to complete the fabrication of a single solid oxide fuel cell.

The durability of the solid oxide fuel cell can be further increased. In this durability increasing method, a metal mesh is embedded in or fixed to each of the cathode electrode and anode electrode layers of the fuel cell. This metal mesh or metal wire may also be used as a current collecting electrode of the solid oxide fuel cell to increase the current collecting efficiency. In the case of the embedding method, the material (paste) for forming each layer is applied over the solid oxide substrate, and the metal mesh is embedded in the thus applied material, which is then calcined. In the case of the fixing method, the metal mesh is not completely embedded in each layer material but may be fixed on a surface of it, followed by sintering.

For the metal mesh, a material that has excellent heat resistance, and that well matches the thermal expansion coefficient of the cathode electrode layer and anode electrode layer which the metal mesh is to be embedded in or fixed to, is preferred. Specific examples include a platinum metal and a platinum-containing metal alloy formed in the shape of a mesh. Alternatively, stainless steel of SUS 300 series (304, 316, etc.) or SUS 400 series (430, etc.) may be used; these materials are advantageous in terms of cost.

Instead of using the metal mesh, metal wires may be embedded in or fixed to the anode electrode layer and the cathode electrode layer. The metal wires are formed using the same metal material as that used for the metal mesh, and the number of wires and the configuration of the wire arrangement are not limited to any particular number or configuration. The metal meshes or metal wires embedded in or fixed to the anode electrode layer and the cathode electrode layer serve to reinforce the structure so that the solid oxide substrate, if cracked due to its thermal history, etc., will not disintegrate into pieces; furthermore, the metal meshes or the metal wires act to electrically connect cracked portions.

The above description has been given by dealing with the case where the solid oxide substrate is formed in a porous structure, but it will be recognized that when the solid oxide substrate of the fuel cell is formed in a closely compacted structure, the metal meshes or the metal wires embedded in or fixed to the cathode electrode layer and the anode electrode layer provide particularly effective means to cope with the problem of cracking due to thermal history.

Cracks can also occur in the solid oxide fuel cell because of rapid heating when the gas space heater is turned on; however, when the metal meshes or metal wires are embedded or buried at a suitable density in the cathode electrode layer and the anode electrode layer, the metal meshes or metal wires act to conduct the heat evenly over the surface of the fuel cell during rapid heating, thus serving to prevent cracking that could occur due to uneven heat conduction.

The metal mesh or the metal wires may be provided in both the anode electrode layer and the cathode electrode layer or in either one of the layers. Further, the metal mesh and the metal wires may be used in combination. When the metal mesh or the metal wires are embedded at least in the anode electrode layer, then if cracking occurs due to thermal history, the power generation performance of the fuel cell does not degrade and the fuel cell can continue to generate power. As the power generation performance of the solid oxide fuel cell is largely dependent on the effective area of the anode electrode layer as the fuel electrode, the metal mesh or the metal wires should be provided at least in the anode electrode layer.

The thus fabricated solid oxide fuel cell is used as the fuel cell C in the solid-oxide fuel-cell power generating apparatus of the present embodiment. In the present embodiment, the premixed gas combustion flame produced by the burner of the gas space heater is directly used as the fuel to be supplied to the anode electrode layer 3 formed on the solid oxide fuel cell. The temperature of the heat generated by the premixed gas combustion flame is substantially the same as that of the flame generated in the apparatus of FIG. 5, which means that the solid oxide fuel cell can be operated with the premixed gas combustion flame. Accordingly, the burner of the gas space heater provides combustion suitable not only as the fuel supply source but also as the driving heat source for the solid oxide fuel cell.

Next, a description will be given of the gas space heater that is used as the fuel supply source for the solid oxide fuel cell in the power generating apparatus of the present embodiment.

A traditionally known infrared radiant gas space heater may be used as the fuel source in the present embodiment. This kind of gas space heater is equipped with a gas burner for burning a fuel gas and also with an infrared radiator which is exposed to the flame produced by the burner. First, a fuel gas is injected at high speed into the gas burner through a small injection port provided in one end of the burner body. Utilizing the pressure drop occurring at this time, air is drawn into the gas burner. The fuel gas and the air are mixed together inside the gas burner body.

The mixture gas thus produced inside the gas burner body is introduced into a plurality of burner ports, i.e., openings for burning, formed in the other end of the burner body. When the infrared radiator is a flat plate, the plurality of burner ports are usually arranged in straight lines so that the produced flames can be uniformly applied to the radiator. For example, when two infrared radiators are provided, two arrays of burner ports arranged in straight lines are employed. In some infrared gas space heaters, the plurality of burner ports are arranged in a circular pattern rather than in straight lines.

When the mixture gas injected through the plurality of burner ports is ignited, the fuel burns at each burner port, forming a premixed gas combustion flame. In this flame, the flow of the mixture gas injected upward through the burner port and the propagation of the flame produced by the burning of the mixture gas are in equilibrium, forming a flame front, the flame being anchored in the burner port and stable combustion takes place.

Conventional gas space heaters are designed to be able to adjust the amount of gas combustion; here, as incomplete combustion may occur if the air/fuel mixture ratio is not properly adjusted, the gas space heaters are also equipped with mechanisms for adjusting the amount of air to match the amount of gas combustion. The fuel gas is adjusted to be burned in an environmentally clean condition, and a stable premixed gas combustion flame is produced. As the premixed gas combustion flame contains radicals and unburned components, the flame is advantageously used as the fuel for the solid oxide fuel cell used in the power generating apparatus of the present embodiment; furthermore, the premixed gas combustion flame can be stably supplied and can advantageously be used to obtain a stable amount of power generation.

City gas, such as liquefied natural gas (LNG), petroleum cracking gas, and liquefied petroleum gas (LPG), is used as the fuel for the infrared gas space heater. The premixed gas combustion flame produced by burning such city gas is suitable as a fuel for the solid oxide fuel cell used in the power generating apparatus of the present embodiment because, as described above, the flame is rich in radicals and unburned components.

In the gas space heater described above, the mixture gas is burned by the burner and a consistent and stable premixed gas combustion flame is formed; as a result, not only can the flame be used as the heat source for the infrared radiator but, because the flame contains radicals produced by the combustion of the fuel, it can also be used as the heat source and fuel source necessary for the power generating operation of the solid oxide fuel cell used in the power generating apparatus of the present embodiment, and thus a direct-flame type fuel-cell power generating apparatus can be constructed that directly utilizes the premixed flame.

By disposing the flat plate solid oxide fuel cell so as to be exposed directly to the premixed flame produced by the burner of the infrared gas space heater, the direct-flame solid-oxide fuel-cell power generating apparatus is constructed which can continue to generate power stably, and from which the power generation output can be easily extracted.

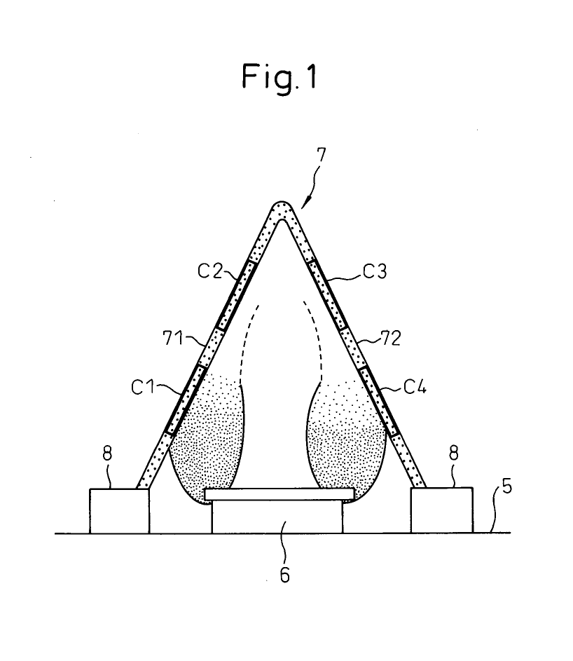

Next, the embodiment of the solid-oxide fuel-cell power generating apparatus that utilizes the premixed gas combustion flame produced by the burner of the infrared gas space heater will be described below with reference to FIGS. 1 to 3 for the case where the power generating apparatus is constructed to be able to generate power while the gas space heater is operating as a space-heating apparatus.

FIG. 1 is a diagram schematically showing the direct-flame solid-oxide fuel-cell power generating apparatus which uses the burner of the gas space heater not only as a source that can supply fuel to the solid oxide fuel cell but also as a heat source for maintaining the fuel cell at its operating temperature. Shown in FIG. 1 is a cross-sectional view of the construction when a conventional infrared gas space heater is used.

The infrared gas space heater comprises a heater base 5, a burner 6, an infrared radiator 7, and a radiator mounting base 8, the burner 6 being located in the center of the heater base 5. A plurality of burner ports are arranged in straight lines along the upper edges of the burner 6; when the mixture gas generated inside the burner body mounted in the heater base is injected through the burner ports and ignites, premixed gas combustion flames F1 and F2 are formed on both sides, as previously described.

In FIG. 1, the infrared radiator 7 comprises radiator plates 71 and 72 formed from a conventionally used infrared radiating material, and the radiator plates are each tilted toward the burner side by a prescribed angle so that the radiator plates can be exposed as evenly as possible to the premixed gas combustion flames F1 and F2 produced by the burner 6. To effectively utilize the premixed gas combustion flames, side walls capable of radiating infrared rays are installed, though not shown in FIG. 1, forming an interior space having a closed top.

Further, to achieve the power generating apparatus of the present embodiment, in the example shown in FIG. 1, solid oxide fuel cells C1 and C2 are built into the radiator plate 71, and solid oxide fuel cells C3 and C4 into the radiator plate 72. If the solid oxide fuel cells are built into the infrared radiator 7, the space-heating performance of the infrared space heater does not drop because, when heated, the solid oxide fuel cells also glow and radiate infrared rays.

The premixed gas combustion flames F1 and F2 produced by the burner 6 are directed upward spreading out at angles ranging from about 20 to 120 degrees relative to the horizontal; therefore, the tilt angle of each radiator plate is optimally selected from within the range of about 40 to 80 degrees relative to the horizontal so that the premixed gas combustion flame can be applied as evenly as possible to the solid oxide fuel cells.

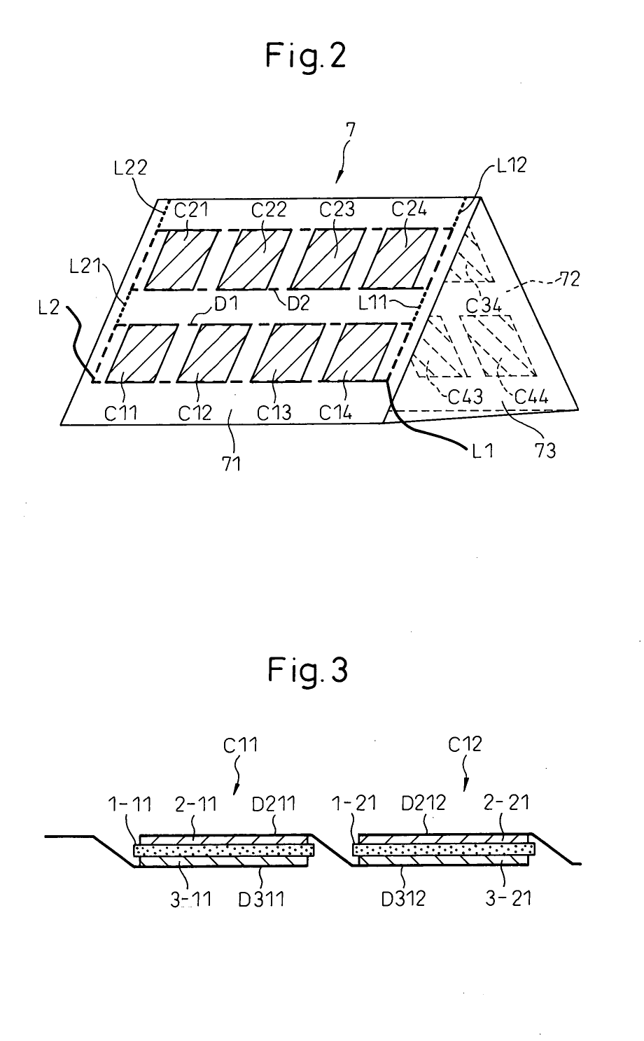

FIG. 2 shows the entire construction of the infrared radiator 7 shown in FIG. 1. This infrared radiator 7 is mounted on the radiator mounting base 8 shown in FIG. 1. In the example of FIG. 2, the solid oxide fuel cells are built into the infrared radiator 7 which comprises, in addition to the radiator plates 71 and 72, radiator plates 73 as side walls, forming the interior space whose top is closed.

The plurality of solid oxide fuel cells are built into the respective radiator plates 71 and 72, as shown. In the radiator plate 71, fuel cells C11 to C14 are arranged as the solid oxide fuel cell array C1, and fuel cells C21 to C24 are arranged as the solid oxide fuel cell array C2. Likewise, in the radiator plate 72, fuel cells C31 and C34 and fuel cells C41 and C44 are arranged as the solid oxide fuel cell arrays C3 and C4, respectively; in FIG. 2, the fuel cells C34, C43 and C44, are shown by dashed lines, but other fuel cells C31 to C33, C41 and C42 are not shown.

The same structure as that of the solid oxide fuel cell C shown in FIG. 5 can be employed for the solid oxide fuel cells built into the infrared radiator 7. To construct the solid-oxide fuel-cell power generating apparatus that utilizes the gas space heater, the solid oxide fuel cells C are arranged with their anode electrode layers 3 facing the burner 6. With this arrangement, the solid oxide fuel cells C are directly exposed to the premixed gas combustion flames produced by the burner 6.

In the above arrangement, the cathode electrode layer of each of the solid oxide fuel cells C11 to C44 faces the outside atmosphere side, i.e., the side opposite from the burner 6. In the example of FIG. 2, a total of 16 solid oxide fuel cells C11 to C44 are arranged into four groups C1 to C4 each consisting of four cells. For example, in the group C1, the solid oxide fuel cells C11 to C14 are connected in series by current collecting electrodes D1, thus forming a series array.

Likewise, in the groups C2, C3, and C4, the individual fuel cells are connected in series by current collecting electrodes, forming respective series arrays. The four series arrays are connected in parallel by lead wires L11, L12, and L13 and lead wires L21, L22, and L23. In FIG. 2, the current collecting electrodes D3 and D4 and the parallel connecting lead wires L12 and L23 on the radiator plate 72 are not shown. The power generation output of the groups C1 to C4 is taken between the lead wires L1 and L2.

Here, a description will be given of an example of how the solid oxide fuel cells are connected within the same group. FIG. 3 shows in detail the solid oxide fuel cells C11 and C12 in the group C1 along with the connection made between them. The solid oxide fuel cell C11 comprise a solid oxide substrate 1-11, a cathode electrode layer 2-11, and an anode electrode layer 3-11, and the solid oxide fuel cell C12 comprise a solid oxide substrate 1-12, a cathode electrode layer 2-12, and an anode electrode layer 3-12, the structure being the same as that of the fuel cell C shown in FIG. 5. The solid oxide fuel cells C11 and C12 are built into the radiator plate 71 with the anode electrode layers 3-11 and 3-12 being arranged so as to be exposed to the premixed gas combustion flame, and with the cathode electrode layers 2-11 and 2-12 facing the outside atmosphere side.

In the fuel cell C of FIG. 5, the lead wires L1 and 12 are attached directly to the respective electrode layers and, using these lead wires, the individual solid oxide fuel cells can be connected in series; in the fuel cells of FIG. 3, on the other hand, the current collecting electrodes, each formed from a metal mesh or metal wire, are provided in order to effectively extract the power generation output of each individual fuel cell. For the solid oxide fuel cell C11, the current collecting electrode D211 is embedded in or attached to the cathode electrode layer 2-11, and the current collecting electrode D212 is embedded in or attached to the anode electrode layer 3-11. The other solid oxide fuel cells are also provided with current collecting electrodes.

Here, to form the series array of the solid oxide fuel cells C11 to C14, the current collecting electrodes provided on the respective fuel cells are used; for example, the current collecting electrode D211 is extended and connected to the current collecting electrode D312. By extending the current collecting electrode in this way, the cathode electrode layer of one fuel cell is electrically connected to the anode electrode layer of another fuel cell adjacent to it. In the case of the fuel cell located at an end of the series array, the current collecting electrode not connected to another current collecting electrode is electrically connected to the parallel connecting lead wire.

When fabricating the infrared radiator 7, the fuel cell series arrays formed as described above are constructed one for each of the four groups C1 to C4, and connected in parallel by the lead wires; then, the series arrays are integrally built into the respective radiator plates. At this time, the solid oxide fuel cells forming each series array are arranged with their anode electrode layers facing the burner side.

The thus fabricated infrared radiator 7 with the solid oxide fuel cells built into it is placed on the radiator mounting base 8, as shown in FIG. 1 and, when the gas spacer heater is turned on, the infrared radiator 7 is heated by the premixed gas combustion flames produced by the burner 6, and the gas space heater functions as the space heater; at the same time, the solid oxide fuel cells are heated and held at their operating temperature by the heat generated by the premixed gas combustion flames produced by the burner, and hence the radicals or unburned components contained in the flames are directly fed to the anode electrode layers.

On the other hand, the cathode electrode layer of each solid oxide fuel cell is located on the side opposite from the burner 6, and is therefore supplied with a sufficient amount of oxygen. Here, in each solid oxide fuel cell, the fuel-rich condition in the anode electrode layer and the oxygen-rich condition in the cathode electrode layer are clearly separated from each other by the radiator plate. The lead wire L1 is connected to the cathode electrode layer, and the lead wire L2 to the anode electrode layer; with these lead wires L1 and L2, the generated power is extracted outside the fuel cell.

In the example of the infrared radiator shown in FIG. 2, the plurality of solid oxide fuel cells have been arranged into four groups C1 to C4 each consisting of four fuel cells, but the number of built-in fuel cells and the method of series or parallel connection can be suitably chosen according to the required power generation output. Further, solid oxide fuel cells can also be built into the side walls of the infrared radiator to effectively utilize the premixed gas combustion flames produced by the burner.

In the example of the solid-oxide fuel-cell power generating apparatus described above, the burner 6 used as the heat source and the fuel source for the solid oxide fuel cells has been described as having two arrays of burner ports arranged in straight lines but, depending on the type of infrared gas space heater, the infrared radiator may comprise a single radiator plate, unlike the construction shown in FIG. 1; in that case, the solid oxide fuel cells are built into the single radiator plate.

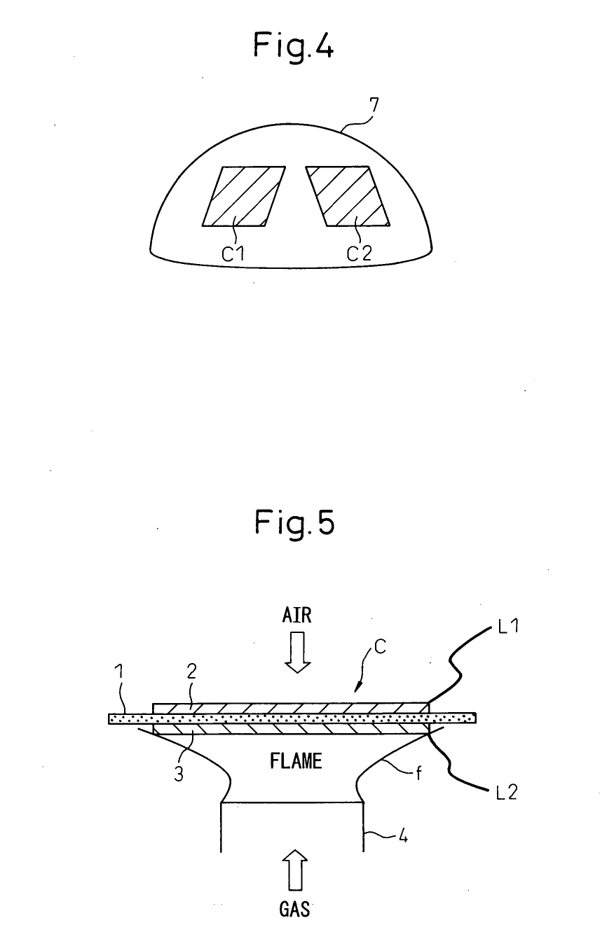

In the solid-oxide fuel-cell power generating apparatus according to the present embodiment so far described, the solid oxide fuel cells have been described as being built into the radiator plates forming the infrared radiator, but certain types of infrared space heater may have semicircular infrared radiators. FIG. 4 shows a modified example of the solid-oxide fuel-cell power generating apparatus, in which a plurality of solid oxide fuel cells are built into a semicircular infrared radiator 7.

In FIG. 4, the infrared radiator 7 is semicircular in shape, but the method of installing the solid oxide fuel cells is substantially the same as that shown in FIG. 2. The burner of the gas space heater having a semicircular infrared radiator usually has annularly arranged burner ports, and the premixed gas combustion flame formed is generally circular in shape; therefore, the solid oxide fuel cells should be installed in a suitably slanted fashion so that the fuel can be effectively supplied to the fuel cells. Further, the solid oxide fuel cells themselves may be curved to conform to the semicircular shape.

In the above modified example of the solid-oxide fuel-cell power generating apparatus also, the cathode electrode layer of each of the solid oxide fuel cells C1 and C2 is located on the side opposite from the burner, and is therefore supplied with a sufficient amount of oxygen. Here, in each of the solid oxide fuel cells C1 and C2, as the atmosphere side and the burner side are separated from each other by the infrared radiator 7, the fuel-rich condition in the anode electrode layer and the oxygen-rich condition in the cathode electrode layer can be easily created, and power can be generated stably and easily.

### EXAMPLE

Next, an example will be described for the solid-oxide fuel-cell power generating apparatus of the present embodiment. A solid-oxide fuel-cell power generating apparatus was fabricated in accordance with the power generating apparatus shown in FIG. 2, and a power generation experiment was conducted using the premixed flames formed in a gas space heater.

First, a solid electrolyte formed from samaria-doped ceria (SDC, Sm_{0.2}Ce_{0.8}O_{1.9} ceramic) was used as the solid oxide substrate. Using a green sheet process, the solid electrolyte was calcined at 1300° C. in the atmosphere to produce a rectangular ceramic substrate. Next, a paste prepared by mixing samaria strontium cobaltite (SSC, Sm_{0.2}Sr_{0.5}Ce_{0.8}O₃) and SDC in proportions of 50% by weight to 50% by weight was applied on one surface of the substrate to print a pattern somewhat smaller than the substrate, and the paste was dried.

Further, a paste prepared by mixing nickel oxide containing 8% by mole of lithium in solid solution and SDC in proportions of 75% by weight to 20% by weight, with 5% by weight of rhodium oxide added thereto, was applied on the opposite surface of the substrate to print a pattern somewhat smaller than the substrate, and a platinum mesh as a current collecting electrode was embedded in each surface. Thereafter, the entire structure was calcined at 1,200° C. in the atmosphere to produce a single rectangular solid oxide fuel cell; further, the current collecting electrode on the anode electrode layer side was electrically connected to the current collecting electrode on the cathode electrode layer side of an adjacent fuel cell, and the fuel cells were built into a radiator plate to fabricate an infrared radiator.

In this example, unlike the case of the infrared radiator shown in FIG. 2, the plurality of solid oxide fuel cells were arranged into six parallel arrays each consisting of five cells connected in series, and three parallel arrays were built into each radiator plate. In FIG. 2, the infrared radiator was provided with side walls 73, but in this power generation experimental example, such side walls were not installed. The gas spreading angle of each premixed gas combustion flame produced by the burner of the gas space heater was in the range of about 20 to 160 degrees, and the tilt angle of the installed solid oxide fuel cells was about 60 degrees.

The infrared radiator with the power generating apparatus incorporated therein was mounted to the gas space heater, after which the mixture gas injected through the burner was ignited, and the solid oxide fuel cells were exposed to the premixed gas combustion flames produced. As a result, an open circuit voltage of about 3.4 V was confirmed, and a maximum power output of about 530 mW was obtained. In this power generation experimental example, as the infrared radiator was not provided with side walls, fuel components for the fuel cells leaked from both sides of the radiator. Here, if an interior space having a closed top is formed inside the infrared radiator, such fuel components do not leak outside, but effectively contribute to the power generating operation of the fuel cells.

What is claimed is:

1. A solid-oxide fuel-cell power generating apparatus comprising:
a solid oxide fuel cell having a solid oxide substrate, a cathode electrode layer formed on one surface of said substrate, and an anode electrode layer formed on a surface of said substrate opposite from said one surface; and
an infrared radiator which supports said solid oxide fuel cell in such a manner that said anode electrode layer is directly exposed to a premixed gas combustion flame produced by a burner of a gas heater, wherein
power is generated by supplying components of said premixed gas combustion flame to said anode electrode layer and air to said cathode electrode layer.

2. A solid-oxide fuel-cell power generating apparatus as claimed in claim 1, wherein a current collecting electrode provided in either one or both of said cathode electrode layer and said anode electrode layer is formed from a metal mesh or metal wire spreading over the entire surface of said electrode layer.

3. A solid-oxide fuel-cell power generating apparatus as claimed in claim 1, wherein said solid oxide fuel cell is supported on said infrared radiator in such a manner as to tilt at a prescribed angle.

4. A solid-oxide fuel-cell power generating apparatus as claimed in claim 1, wherein said solid oxide fuel cell is integrally built into said infrared radiator with said anode electrode layer facing said burner.

5. A solid-oxide fuel-cell power generating apparatus as claimed in claim 4 wherein, when said burner is constructed to produce said premixed gas combustion flame in such a manner as to form an array of premixed gas combustion flames arranged in a straight line, said solid oxide fuel cell is built into said infrared radiator so that the surface of said anode electrode layer runs parallel to a direction in which said premixed gas combustion flames are arranged.

6. A solid-oxide fuel-cell power generating apparatus as claimed in claim 4, wherein a plurality of said solid oxide fuel cells are built into said infrared radiator, and
said plurality of solid oxide fuel cells are connected in series or parallel to each other and are provided with lead wires for extracting a power generation output.

7. A solid-oxide fuel-cell power generating apparatus as claimed in claim 6, wherein current collecting electrodes provided in said cathode layers and said anode layers of said plurality of solid oxide fuel cells are each formed from a metal mesh or metal wire, and
said plurality of solid oxide fuel cells are connected in series or parallel to each other by said metal mesh or metal wire extending from said current collecting electrode of each of said solid oxide fuel cells.

8. A solid-oxide fuel-cell power generating apparatus as claimed in claim 1, wherein said infrared radiator forms an interior space having a closed top, and
said premixed gas combustion flame produced by said burner is supplied into said interior space.

9. A solid-oxide fuel-cell power generating apparatus as claimed in claim 1, wherein said solid oxide fuel cell comprises a plurality of cathode electrode layers formed on one surface of said solid oxide substrate and a plurality of anode electrode layers formed on a surface of said solid oxide substrate opposite from said one surface, and a plurality of fuel cells are formed by said anode electrode layers and said cathode electrode layers formed opposite each other across said solid oxide substrate.
